(19) United States
(12) Patent Application Publication
(10) Pub. No.: US 2022/0292385 A1
(43) Pub. Date: Sep. 15, 2022

(54) FLEXIBLE INITIALIZER FOR ARBITRARILY-SIZED PARAMETRIZED QUANTUM CIRCUITS

(71) Applicant: Zapata Computing, Inc., Boston, MA (US)

(72) Inventor: Frederic Sauvage, London (GB)

(21) Appl. No.: 17/691,493

(22) Filed: Mar. 10, 2022

Related U.S. Application Data
(60) Provisional application No. 63/176,436, filed on Apr. 19, 2021.

(30) Foreign Application Priority Data
Mar. 10, 2021 (FR) 2102364

(51) Int. Cl. G06N 10/60; G06N 10/20; G06N 3/04; G06N 3/08

(52) U.S. Cl. CPC G06N 10/60; G06N 10/20; G06N 3/0454; G06N 3/084

(57) ABSTRACT

A method and system are provided for optimizing parameters of a parametrized quantum circuit (PQC), using machine learning to train a flexible initializer for arbitrarily-sized parametrized quantum circuits. The disclosed technology may be applied to families of PQCs. Instead of using a generic or random set of initial parameters, the disclosed technology learns the structure of successful parameters from a family of related problem instances, which are then used as the machine learning training set. The method may predict optimal initializing parameters for quantum circuits having a larger number of parameters than those used in the training set.

### BACKGROUND

### Field of the Technology Disclosed

The disclosed technology relates to a method and system for creating an optimal set of initializing parameters for a parametrized quantum circuit (PQC) using machine learning methods.

### Description of Related Art

The subject matter discussed in this section should not be assumed to be prior art merely as a result of its mention in this section. Similarly, any problems or shortcomings mentioned in this section or associated with the subject matter provided as background should not be assumed to have been previously recognized in the prior art. The subject matter in this section merely represents different approaches, which in and of themselves can also correspond to implementations of the claimed technology.

Variational quantum algorithms (VQAs) are a class of algorithms suitable for near-term quantum computers. Their applications include quantum simulation and combinatorial optimization, as well as tasks in machine learning, such as data classification, compression, and generation. Variational quantum algorithms provide a viable approach for achieving quantum advantage for real-world applications in the near term. At the core of these near-term quantum algorithms is a parametrized quantum circuit (PQC) which acts as the quantum model needed to train a specific problem. Optimizing PQCs remains is a difficult task. Currently, only optimizations over small circuit sizes have been realized experimentally. Several obstacles limit the scaling of VQAs to larger problems. In particular, the presence of many local minima and barren plateaus in the optimization landscape preclude successful optimizations for even moderately small problems. Furthermore, contrary to classical machine learning pipelines, the overhead in obtaining gradient descents (GD) scales linearly with the number of parameters, which limits the number of iterations that can be realistically performed. The disclosed technology addresses and provides a solution to these drawbacks.

### SUMMARY

In one aspect, the disclosed method successfully generates a set of initial parameters for a parametrized quantum (PQC) circuit, without using random selection of initial parameters as in competitive technologies. Extending ideas from the field of meta-learning, the parameter initialization method uses machine learning to provide a flexible initializer for arbitrarily-sized parametrized quantum circuits. The disclosed method is hereinafter referred to as FLIP, which stands for flexible initializer for arbitrarily-sized parametrized quantum circuits. Any reference herein to FLIP should be understood to refer to certain embodiments, and not necessarily to all embodiments, of the claims herein.

The disclosed technology provides flexibility in several areas. For example, FLIP can be applied to any family of PQCs, and instead of relying on a generic set of initial parameters, it is tailored to learn the structure of successful parameters from a family of related PQC problems, which are used as the training set. The flexibility of FLIP provides a method of predicting the initialization of parameters in quantum circuits with a larger number of parameters from those used in the training phase. This is a critical feature lacking in other initializing strategies proposed to date. The advantages of using FLIP are apparent in three scenarios: a family of problems with proven barren plateaus, PQC training to solve max-cut problem instances, and PQC training for finding the ground state energies of 1D Fermi-Hubbard models.

The disclosed technology for training PQCs unlocks the full potential offered by VQAs by addressing drawbacks from an initialization perspective. In one aspect of the disclosed technology, a method for a flexible initializer for arbitrarily parameterized quantum circuits is provided. This initializer is trained, using machine learning methods, on a family of related problems, so that, after training, it can be used to initialize the circuit parameters of similar but new problem instances.

In one aspect, rather than relying on a generic set of initial parameters, the initial parameters produced are specially tailored for families of PQC problems and may be conditioned on specific details of the individual problems. In another aspect, the method operates effectively, regardless of the PQCs employed. The method may be used for any families of PQCs. And in another aspect, the method may accommodate quantum circuits of different sizes (in terms of the number of qubits, circuit depth, and number of variational parameters), within the targeted family, both during its training and in subsequent applications.

The disclosed technology has several practical advantages. During training, smaller circuits may be included in the dataset to help mitigate the difficulties arising in the optimization of larger ones. Once trained, the method demonstrates dramatically improved performance compared with random initialization. Also, the method is easier to train. After training, the method may be successfully applied to the initialization of larger quantum circuits than the ones used for its training. In one aspect, the method may be trained on problem instances that are numerically simulated, and subsequently be used on larger problems run on a quantum device. This method advantageously uses inexpensive computational resources to leverage the latest advances in the numerical simulation of quantum circuits. The quantum circuits may be scaled upwardly so that the VQAs may encompass previously intractable problems.

In one embodiment of the disclosed technology, a generic parametrized quantum circuit (PQC) problem is composed of a parametrized circuit ansatz U(θ) and an objective C, which can be estimated through repeated measurements on the output state |ψ(θ) [symbol] =U(θ)|ψ0 [symbol] . Solving a PQC problem corresponds to the minimization of the cost function C(θ)=C(|ψ(θ) [symbol] ). An example of a PQC problem may be for a system size of N=3 qubits, and a quantum circuit U with K=6 parameters. FLIP includes an encoding-decoding scheme which maps a PQC problem to a set of initial parameters θ(0). Each of the K parameters of the quantum circuit U is first represented as an encoding vector hₖ. This encoding contains information about the parameter itself, the overall circuit, and optionally the objective. Importantly, each of the encodings is of fixed size (S=5) and uniquely represents each parameter. These K encodings are then decoded by a neural network, D_{ϕ}, with weights ϕ, outputting a single value θ(0)ₖ per encoding hₖ.

This encoding-decoding scheme always produces a vector of initial parameters θ(0) with the dimension matching the number of circuit parameters. These parameters θ(0) are used as the starting point for gradient descent (GD) optimization. During training of FLIP, the weights ϕ of the decoder are tuned to minimize the meta-loss function L(ϕ), corresponding to the value of the cost after s steps of GD. Gradients of this loss can be back-propagated to the weights ϕ of the decoder, which are updated accordingly. In practice, the FLIP method may be trained over PQC problems sampled from a distribution of problems C_{τ}˜p(C) and tested over new problems drawn from the same or a similar distribution. The new problems may involve larger system sizes and deeper circuits.

### BRIEF DESCRIPTION OF THE DRAWINGS

The disclosed technology, as well as a preferred mode of use and further objectives and advantages thereof, will best be understood by reference to the following detailed description of illustrative embodiments when read in conjunction with the accompanying drawings. In the drawings, like reference characters generally refer to like parts throughout the different views. The drawings are not necessarily to scale, with an emphasis instead generally being placed upon illustrating the principles of the technology disclosed.

FIG. 1 is a diagram of a quantum computer according to one embodiment of the present invention;

FIG. 2A is a flowchart of a method performed by the quantum computer of FIG. 1 according to one embodiment of the present invention;

FIG. 2B is a diagram of a hybrid quantum-classical computer which performs quantum annealing according to one embodiment of the present invention; and

FIG. 3 is a diagram of a hybrid quantum-classical computer according to one embodiment of the present invention.

FIG. 4 shows an overview of a flexible initializer for arbitrarily-sized parametrized quantum circuits;

FIGS. 5A, 5B, and 5C illustrate the factors involved in solving state preparation problems;

FIGS. 6A, 6B, and 6C illustrate the use of the flexible initializer for QAOA applied to max-cut problems;

FIGS. 7A and 7B illustrate the optimization results for the 1D Fermi-Hubbard model (1D FHM); and

FIG. 8 is a block diagram illustrating the basic process flow of the flexible initializer.

### DETAILED DESCRIPTION

### Overview

The disclosed technology is, in one embodiment, a flexible initializer for arbitrarily-sized parametrized quantum circuits (FLIP). The method and system of the disclosed technology is for accelerating optimization over targeted families of parametrized quantum circuit (PQC) problems. Efficient optimization is approached from an initialization perspective, for learning a set of initial parameters which can be efficiently refined by gradient-descent.

In competing methods, the number of parameters to be optimized is fixed, thus restricting their applicability to quantum circuits of fixed sizes. The disclosed technology is flexible to accommodate arbitrarily-sized circuits. In a further aspect, the method also allows incorporation of any relevant information about the problems to be optimized, thus producing fully problem-dependent initial parameters.

### Learning Over a Family of Related PQC Problems

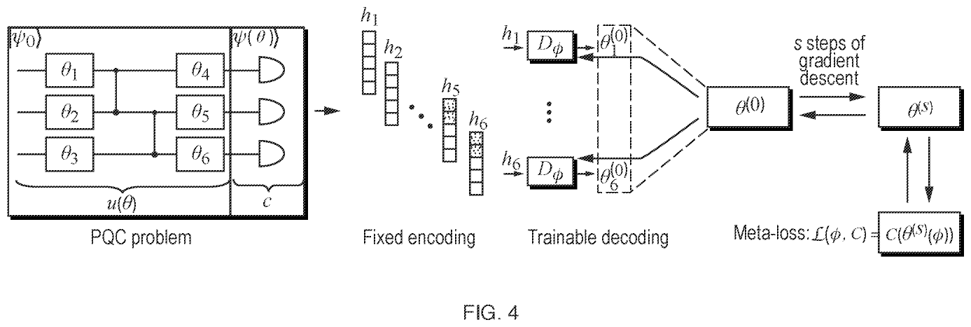

A generic PQC problem corresponds to a cost C(θ)=C(U(θ)|ψ0 [symbol] ) to be minimized, where U(θ) denotes a parametrized circuit applied to an initial state |ψ0 [symbol] , and C denotes an objective evaluated on the output of the circuit, as illustrated in FIG. 4.

The objective is defined as any function which can be estimated based on measurement outcomes. For instance, the objective may be the expectation value C(|ψ [symbol] )= [symbol] ψ|O|ψ [symbol] of a Hermitian operator O as it is often the case in VQAs, or a distance to a probability distribution. There is a subtle distinction between the objective C(|ψ [symbol] ), which is unknown with respect to the quantum circuit employed, and the (PQC problem) cost C(θ) which is a function of the parameters θ and depends upon both the objective and the choice of parametrized quantum circuit.

Rather than considering any such PQC problem independently, the following discussion focuses on families of related, similar problems indexed by τ and drawn from a probability distribution, i.e., C_{τ}˜p(C). Such a distribution can be obtained by fixing the circuit ansatz U while varying the objective C_{τ}˜p(C), or by fixing the objective and allowing for different quantum circuits U_{τ}˜p(U). More generally, both the underlying objective and quantum circuits are varied.

Herein, the aim is to exploit meaningful parameters patterns over distributions of PQC problems. Some restrictions will be imposed on the way these distributions are defined. Also, in the following, distributions are considered over quantum circuits of various sizes but with the same underlying structure, and over objectives with the same attributes. The exact details of the distributions used are made explicit when showing the results.

### Initialization-Based Meta-Learning

Meta-learning, i.e., learning how to efficiently optimize related problems, has a rich history in machine-learning. Focusing now on a subset of such techniques, initialization-based meta-learners, in which the knowledge about a distribution of problems p(C) is summarized into a single set of parameters θ⁽⁰⁾ which is used as a starting point of a gradient-based optimization for any problem C_{τ}˜p(C), as initial parameters of a gradient-based optimization.

These initial parameters are trained to minimize the meta-loss function

[symbol]

(θ⁽⁰⁾)=∫p(C)C_{τ}(θ_{τ}^{(s)})dC

where the parameters θ^{(s)}_{τ}, for the problem C_{τ}, are obtained after s steps of gradient descent.

For instance, for a single step, s=1, of gradient descent θ⁽¹⁾_{τ}=θ⁽⁰⁾−η∇_{θ}C_{τ}(θ⁽⁰⁾). In practice, this number of steps is taken to be small (s<10) but not null. The case s=0 corresponds to finding good parameters on average rather than good initial parameters. In some cases, even s=1 can produce drastically different and better parameters than the s=0.

Training these initial parameters θ⁽⁰⁾ is performed via gradient descent of the loss function, which requires the evaluation of the terms ∇_{θ}⁽⁰⁾ C_{τ}(θ^{(s)}_{τ}) where θ^{(s)}_{τ} depends implicitly on θ⁽⁰⁾. These terms can be obtained by the chain rule but involve second-order derivatives (Hessian) of the type ∇_{θi,θj}C_{τ}(θ). Evaluating these second-order terms is costly in general and even more in the context of quantum circuits. Fortunately, approximations of the gradients of the loss involving only first-order terms have been found to work well empirically. The following approximation

$${∇}_{{θ}^{( 0 )}} C ( {θ}_{τ}^{( s )} ) \approx \frac{{θ}_{τ}^{( s )} - {θ}^{( 0 )}}{η} ,$$

has been shown to be competitive and allows for a straightforward implementation.

### Encoding-Decoding of the Initial Parameters

The meta-learning approach requires the set of initial parameters θ⁽⁰⁾ to be shared by any of the problems C_{τ}˜p(C), requiring the problems to have the same number of parameters. However, good initial parameters for a given PQC problem be applicable for related problems, even for different sizes. For instance, the ground state preparation of an N-particle Hamiltonian probably could share some resemblance with the preparation of the ground state of a similar but extended N+ΔN-particle system. Likewise, optimal parameters for a quantum circuit of depth d may be informative about an adequate range of parameter values for a deeper circuit of depth d+Δd.

The existence of such circuit parameters patterns, both as a function of the size of the system and of the depth of the circuit, has been observed in the context of QAOA or max-cut problems and for the long-range Ising model. This provides motivation to extend the idea of learning good initial parameters for fixed-size circuits to learning good patterns of initial parameters over circuits of arbitrary sizes.

The disclosed technology introduces a novel encoding-decoding scheme, mapping the description of a PQC problem to a vector of parameter values with adequate dimension. The encoding part of this map is fixed, while the decoding part can be trained to produce good initial parameter values. In addition, this mapping allows the initial parameters to be conditioned to the relevant details of the objective, so that they can be incorporated in the description of the PQC problem produced by the encoding strategy. The general idea for a single PQC problem is illustrated in FIG. 4.

Each parameter, indexed by k, of an ansatz U_{τ}, is encoded as a vector h^{τ}ₖ containing information about the specific nature of the parameter and of the ansatz. It includes, for example, the position and type of the corresponding parametrized gate, and the dimension of the ansatz. Several choices could be made, but importantly this encoding scheme results in encoding vectors of the same dimension S for each parameter, i.e., ∀k, τ, dim (h^{τ}ₖ)=S and that distinct parameters and circuits have distinct representations, i.e., ∀k≠k′, h^{τ}ₖ≠h^{τ}ₖ′ and ∀U_{τ}≠U_{τ}′, h^{τ}ₖ≠h^{τ′}ₖ.

Once this choice of encoding is taken, any PQC problem containing an arbitrary number of parameters K is mapped to K of such encodings. These are then fed to a decoder, denoted D_{ϕ}, with weights ϕ, which is the trainable part of the scheme. This decoder is taken to be a neural network with input dimension S and output dimension one; that is, for any given encoding h^{τ}ₖ it outputs a scalar value, and when applied to K of such encodings, it outputs a vector of dimension K which contains the initial parameters θ⁽⁰⁾_{τ} for the problem C_{τ} to be used in the meta-learning framework.

In addition to the details of the parameters and ansatz, embodiments of the present invention may also extend the encoding to incorporate objective-specific details, which is relevant information about the objective C. This extension the production of fully problem-dependent initial parameters.

### Training and Testing

Training FLIP may include learning the weights ϕ of the decoder to minimize the loss-function, such as shown in the following:

[symbol]

(ϕ)=∫p(C)C_{τ}(θ_{τ}^{(s)}(ϕ))dC

where the parameters θ^{(s)}_{τ}(ϕ) are now obtained after s steps of gradient-descent performed from the initial parameters θ⁽⁰⁾_{τ}(ϕ) outputted by the decoder (the dependence to the decoder weights ϕ has been made explicit here). As illustrated in FIG. 4, the gradients needed to minimize this loss function are obtained by virtue of the chain rule:

∇_{ϕ}C_{τ}(θ_{τ}^{(s)})=∇_{θ}_{ᵣ}_{⁽⁰⁾}C_{τ}(θ_{τ}^{(s)})·∇_{ϕ}θ_{τ}⁽⁰⁾,

where the new Jacobian term ∇_{ϕ}θ⁽⁰⁾_{τ} contains derivatives of the output of the neural network D_{ϕ} for the different encodings h^{τ}ₖ. In practice, each step of training of FLIP consists of drawing a small batch of problems from the problem distribution p(C) and using the gradients in prior equation averaged over these problems to update the weights ϕ.

Finally, once trained, the framework is applied to unseen testing problems. Testing problems, indexed by τ′, are sampled from a distribution Cτ′˜p′(C). When presented to a new problem C_{τ′}, the encoding-decoding scheme is used to initialize the corresponding quantum circuit U_{τ′}, from which s′ steps (typically larger than the number of steps s used for training) of gradient descents are performed.

### Operation

FLIP is put into practice starting with state preparation problems using simple quantum circuits. The construction of a distribution of problems, where both the target states and sizes of the circuits are varied, highlights how various problems may be circumvented, such as barren plateaus arising from random initialization of the circuits. FLIP may then be applied to other VQAs. For example, the quantum approximate optimization algorithm (QAOA) in the context of max-cut problems may be considered. Because QAOA has been used extensively, benchmarking against this and other competitive initialization alternatives can provide further investigations into the learned patterns of initial parameters.

Hardware-efficient ansatzes are tailored to exploit the physical connections of quantum hardware. Typically, they aim at reducing the depth of quantum circuits, and thus the coherence-time requirements, at the expense of introducing many more parameters to be optimized. If successfully optimized, they may offer practical applications in the near-term. The FLIP method may be applied to ground state preparation of the one-dimensional Fermi-Hubbard model (1D FHM) employing the low-depth circuit ansatz (LDCA). In all these examples the advantage of FLIP is demonstrated over random initialization and other alternatives. Also, it may be demonstrated to systematically assess the ability of the disclosed technology to successfully initialize larger circuits than the ones it was exposed to during training.

### Mitigating Barren Plateaus in State Preparation Problems

Rather than considering the preparation of a single target state |ψ^{tgt} [symbol] , a family of target states |ψ^{tgt}_{τ} [symbol] are considered, which are computational basis states with only one qubit in the |1 [symbol] state, at target position p_{τ}. The objective is to generate problems, indexed as usual by τ, where both the size of the target state nτ and the position pτ can be varied. For example, for nτ=3 qubits, and a position pτ=2, the target state reads |ψ^{tgt}_{τ} [symbol] =101 [symbol] ).

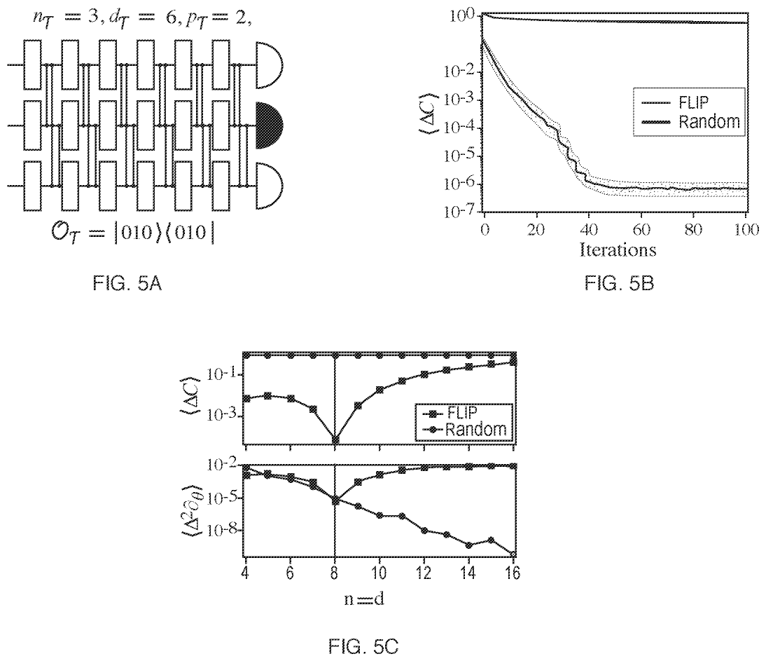

The quantum circuits comprise d_{τ} layers of parametrized single qubit gates R_{y}(θ) applied to each qubit, followed by controlled-Z gates acting on adjacent qubits (where the first and last qubits are assumed to be adjacent). The resulting parametrized circuits contain K_{τ}=n_{τ}d_{τ} variational parameters. The objective to be minimized is taken to be the negated fidelity C_{τ}(θ)= [symbol] ψ(θ)|O_{τ}|ψ(θ) [symbol] , with O_{τ}=−|ψ^{tgt}_{τ} [symbol] [symbol] ψ^{tgt}_{τ}|. The distributions of problems are thus specified by defining how to sample the integers n_{τ}, d_{τ} and p_{τ}. A single problem with n_{τ}=3 qubits, d_{τ}=6 layers, and position p_{τ}=2 is illustrated in FIG. 5A.

For training, a distribution of problems is considered where the integers nτ∈[1,8] qubits, dτ∈[1,8] layers, and p_{τ}Σ[1,n_{τ}] are uniformly sampled within their respective range. For testing, 50 new problems were sampled with n_{τ′}∈[4,16] qubits, d_{τ′}∈[4,16] layers, and p_{τ′}∈[1,n_{τ′}], from a distribution containing problems supported by the training distribution but also larger problems (with quantum circuits up to twice as wide and as deep as the largest circuit in the training set).

Convergence of the optimizations performed over these testing problems is depicted in FIG. 5B, comparing circuits initialized with FLIP and circuits randomly initialized. In both cases, 100 steps of simple gradient descent are performed after initialization. The absolute minimum of the objective that can be reached for these state preparation problems is Cₘᵢₙ=−1, and the average of the deviation is ΔC=C−Cₘᵢₙ from this minimum as a function of the number of optimization steps.

Quantum circuits initialized by FLIP can be quickly refined to reach an average value of ΔC≈0.1% after fewer than 30 iterations. This is in contrast with optimizations starting with random initial parameters, which even after 100 iterations only achieve an average ΔC≈50%. These individual results show that the benefit of FLIP is particularly appreciable for the largest circuits considered. For problems with n_{τ′}=d_{τ′}≥12, most of the optimizations starting with random parameters fail in even slightly improving the objective, while optimizations of circuits initialized with FLIP converge quickly.

These patterns in optimizations with randomly initialized parameters are symptomatic of barren plateaus. FIG. 5C compares the initial values of the objective and gradients for PQCs initialized randomly and with FLIP. The top panel shows the deviations ΔC=C−Cₘᵢₙ, of the objective values. The bottom panel shows the variances Δ²∂_{θ} of the cost function gradients. Shaded regions indicate circuit sizes seen by FLIP during training.

For random initialization, the deviations of the objective value are always close to its maximum value 1, i.e., far away from the optimal parameters. Furthermore, FIG. 5 shows that amplitude of the gradients exponentially vanishes with the system size, thus preventing successful optimizations.

Quantum circuits initialized with FLIP exhibit strikingly different patterns. For problem sizes n≤8 qubits, seen during training (shaded regions), both the objective and the gradient amplitudes are small, showing that FLIP successfully learned to initialize parameters close to the optimal ones. When the size of the circuits is increased further (e.g., n>8, n>16, n>32, or n>64), the objective values increase, indicating that circuits are initialized further away from ideal parameters. This degradation is expected as FLIP needs to extrapolate initial parameters patterns ranging from small circuits to new, larger circuits. Nonetheless, in all cases the values of the initial objective are demonstrated to be significantly better than those obtained for random initialization. Also, the amplitudes of the initial gradients remain non-vanishing for the range of quantum circuit sizes studied, thus allowing for the fast optimization results, as displayed in FIG. 5B. FLIP remains competitive even when trained and tested with noisy gradients. The FLIP method consistently learns the patterns of good initial parameters with respects to the specific objective details and the circuits dimensions. In these state preparation examples, where the circuit structure is relatively simple, barren plateaus are avoided. In random initialization, barren plateaus would not have been avoided. The disclosed technology thus leads to more practical VQAs.

Max-Cut Graph Problems with QAOA

The Quantum Approximate Optimization Algorithm (QAOA) is an approximate method for optimizing combinatorial problems. Since its proposal, QAOA has received a lot of attention with recent works focusing on aspects of its practical implementation and scaling. Alternating-type ansatze such as QAOA as well as the Hamiltonian Variational have been shown to be parameter-efficient. Still, optimizing such ansatze can be challenging even for small problem sizes, since the optimization landscape is filled with local minima. There are continuing efforts to devise more efficient optimization strategies. We first briefly recall the definition of max-cut problems and of the QAOA ansatz, then apply FLIP and compare it to random initialization and other more sophisticated initialization strategies. While ground state preparation could be attempted with any type of PQCs, it is typical to resort to QAOA ansatze for these problems. A QAOA ansatz is formed of repeating composition of problem and mixer unitaries.

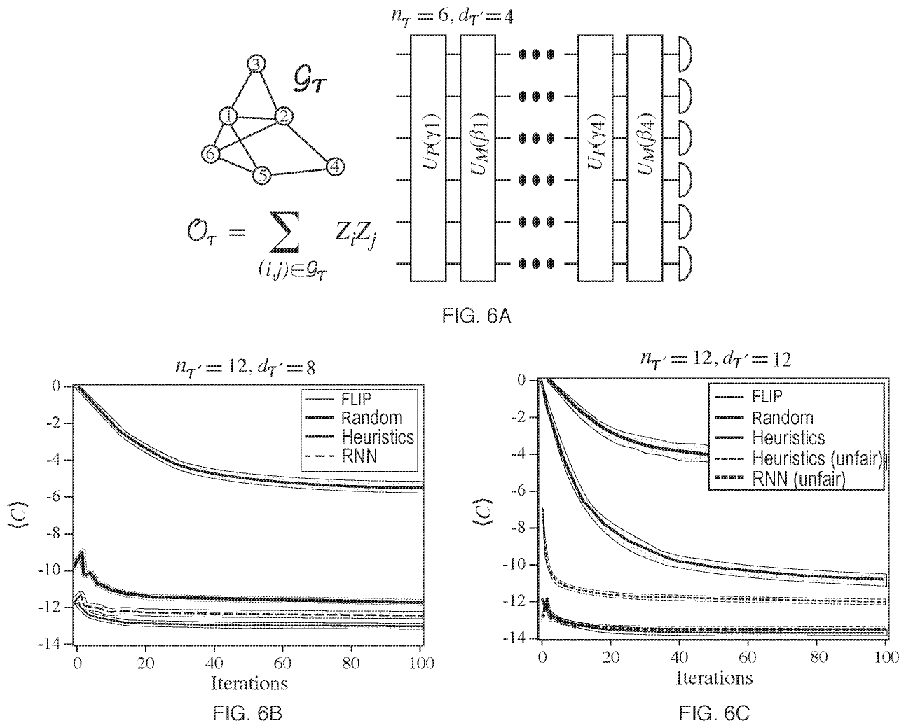

An instance of a QAOA max-cut problem belonging to the training data set is illustrated in FIGS. 6A, 6B, and 6C for the case where d_{τ}=4 layers, n_{τ}=6 nodes and e_{τ}=50%. Optimizations are compared with circuits initialized by the disclosed FLIP method against random initializations, as well as more competitive baselines. This follows the principle that good parameters obtained for a given graph are typically also good for other similar graphs. While these results are obtained for 3-regular graphs and a number of layers smaller than the number of nodes. A general initialization strategy, hereinafter known as heuristics initialization, comprises:
Performing optimization over randomly drawn training problems;
Selecting the set of optimal parameters resulting in the best average objective value over the training problems; and
Reusing these parameters as initial parameters when optimizing new problems.

The two-step training strategy allows mitigation for (i) optimizations trapped in local minima by repeated optimizations, and (ii) ensures that the selected parameters are typically good for many other problems. Results are also included using what is known as the recurrent neural network (RNN) meta-learner approach. An RNN is trained to act as a black-box optimizer. At each step it receives the latest evaluation of the objective function and suggests a new set of parameters to try. After the training, this RNN can be used on new problem instances for a small number of steps. The best set of parameters found over these preliminary steps is subsequently used as initial parameters of a new optimization.

In contrast with FLIP, both the heuristics and the RNN initializer require that all the problem instances share the same number of parameters. For QAOA circuits, this restricts the circuits employed to be of fixed depth, although the number of graph nodes considered can be varied as it does not relate directly to the number of parameters involved. Hence, when training these alternative initializers, we consider a similar training distribution as the one used for FLIP, with the exception that all circuits are taken to be of fixed depth, d_{τ}=8 layers.

A first batch of testing problems are generated for graphs with n_{τ′}=12 nodes and circuits with d_{τ′}=8 layers. Average optimization results (and confidence intervals) over 100 of such testing problem instances are reported in FIG. 6B. The four different initialization strategies previously discussed are compared. The simple heuristic strategy already provides a significant improvement compared to random initialization, thus highlighting the importance of informed initialization of the circuit parameters. An extra improvement is achieved when using the RNN initializer. Finally circuits initialized with FLIP exhibit the best final average performance over these problems. While initial objective values are similar for circuits initialized by FLIP and RNN, the initial parameters produced by FLIP are found to be more auspicious to further optimization.

Results for new testing problems with an increased depth of d_{τ′}=12 layers are displayed in FIG. 6C. The heuristics initial parameters trained on circuits with d_{τ}=8 layers, are adapted to these larger circuits by padding the missing additional parameters entries with random values. However, there is no straightforward way to fairly extend the RNN trained on circuits with d_{τ}=8 layers to these larger circuits. Hence, we include the heuristics and RNN initializer re-trained from scratch on problems with d_{τ}=12 layers. These are labeled as “unfair” in the legend as they are trained on circuits 50% deeper than the largest ones seen by FLIP during its training. Remarkably, even in this challenging set-up, FLIP outperforms all the other approaches, albeit only showing an almost indistinguishable advantage compared to the RNN trained on the d_{τ}=12 layered circuits (ΔC≈0.06).

### Initializing LDCA for the 1D Fermi-Hubbard Model

The Fermi-Hubbard model (FHM) is a prototype of a many-body interacting system, widely used to study collective phenomena in condensed matter physics, most notably high-temperature superconductivity. Despite its simplicity, FHM features a broad spectrum of coupling regimes that are challenging for the state-of-the-art classical electronic structure analyzed the prospect of achieving quantum advantage for the large scale VQE simulations of the two-dimensional FHM, emphasizing the need for efficient circuit parameter optimization techniques, including those based on meta-learning. The one-dimensional FHM (1D FHM), describes a system of fermions on a linear chain of sites with length L. The 1D FHM Hamiltonian is defined as the following in the second quantization form

$${H}_{ID FHM} = - t {\sum }_{σ = ↑ , ↓} {\sum }_{j = 1}^{L - 1} ( {α}_{J + 1 , σ}^{↑} {a}_{j , σ} + {α}_{j , σ}^{↑} {a}_{j + 1 , σ} ) + U {\sum }_{j = 1}^{L} {u}_{j + ↑} {a}_{j , ↓} - μ {\sum }_{σ = ↑ , ↓} {\sum }_{j = 1}^{L - 1} {u}_{j , σ} ,$$

where j indexes the sites and σ indexes the spin projection. The first term quantifies the kinetic energy corresponding to fermions hopping between nearest-neighboring sites and is proportional to the tunneling amplitude t. The second term accounts for the on-site Coulomb interaction with strength U. Symbols nⱼ, σ refer to number operators. Lastly, the third term is the chemical potential μ that determines the number of electrons or the filling. For the half-filling case, in which the number of electrons N is equal to L, μ is set to U/2.

Ground state energies of the 1D FHM over a range of chain lengths are systematically estimated using the VQE algorithm. With increasing system size (chain length) and a corresponding increase in the circuit resources (e.g., depth or gate count) of the respective VQE ansatz, the noise in the quantum device deteriorates the quality of the solutions. The maximum chain length before the device noise dominates the quality of VQE solutions informs the maximum capability of the particular quantum device at solving related algorithm tasks.

Implementation of such VQE benchmark on near-term devices requires a careful design of a variational ansatz with low circuit depth. A candidate for such ansatz is the Low-Depth Circuit Ansatz (LDCA), a linear-depth hardware-inspired ansatz for devices with linear qubit connectivity and tunable couplers. While LDCA was shown to be effective in estimating ground state energies of strongly correlated fermionic systems, its application has been limited to small problem sizes due to the quadratic scaling of parameters with the system size and the corresponding difficulty in parameter optimization. A recent work proposed an optimization method for parameter-heavy circuits such as LDCA, but the reported simulations for LDCA required many energy evaluations on the quantum computer.

For a parameter-heavy ansatz like LDCA, in which the role of each parameter (and its corresponding gate) is not easily understood, it is beneficial to adopt an initialization strategy that is effective across a family of related problem instances. This disclosed technology is a useful strategy for these problem instances.

The following discussion provides details and results for applying FLIP to initialize number-preserving LDCA for 1D FHM problem instances of varying chain lengths L and numbers d of circuit layers (named “sublayers” in LDCA). In all cases the ansatz circuit is applied to non-interacting anti-ferromagnetic initial states with two electrons per occupied lattice site. For this version of LDCA, which conserves the particle number, there are K=3d(n−1)+n parameters where the system size n=2L (two qubits per lattice site).

Training instances for FLIP were generated for a number of sites Lτ∈[1,6], a value of the interaction U_{τ}∈[0,10] and a number of LDCA sublayers d_{τ}∈[1,6]. For each new training problem, these values are sampled uniformly within their respective discrete or continuous ranges and the cost function is taken to be to the expectation value of the l1-normalized version of the problem Hamiltonian. For testing, both the number of sites and of circuit layers are increased to L_{τ′}∈{6,8,10} and d_{τ′}=8 and values of U are taken at regular intervals in the range [0,10]. Optimization results averaged over the testing problems are reported in

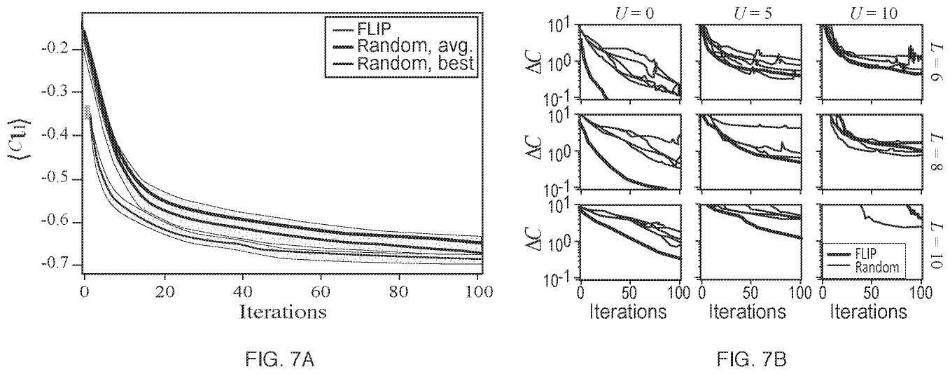

Turning now to FIG. 7A, for random parameter initialization, each problem optimization is restarted five times. Results corresponding to the average over these repetitions or to the best per problem are compared to optimizations of circuits initialized with FLIP. After only 50 steps of optimization, circuits initialized with FLIP achieve similar convergence when compared to 100 steps of optimizations from random initialization for the average (best of five) case. Consideringn individual instances, as can be seen n FIG. 7B, the advantage of the FLIP method is most prominent for the largest circuits (last row) over which it was applied. Importantly, FLIP outperforms random initialization in the strong coupling regime (away from U=0), where the non-interacting initial state generally provides a poor starting point for VQE optimization. It should be emphasized that prior to the disclosed technology no method for initializing parameters of LDCA circuits existed other than assigning random values.

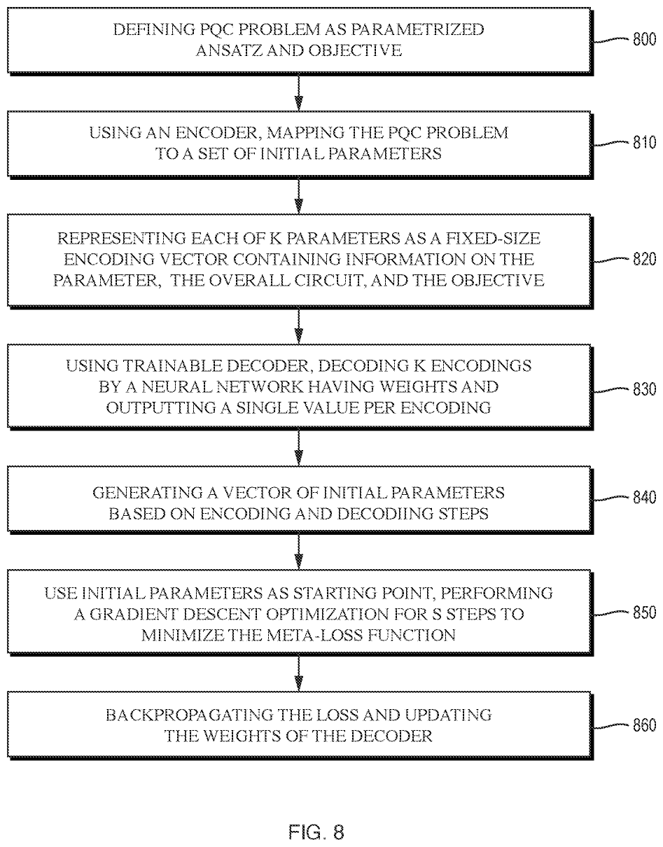

Referring now to FIG. 8, a simplified flowchart for the FLIP method is presented. FLIP may be applied to a single VQA objective but with quantum circuits of varying depths. Rather than growing the circuits sequentially and making incremental adjustments of parameters, FLIP aims at capturing and exploiting patterns in the parameter space and thus can provide a more robust approach. This flexibility towards learning over circuits of different sizes is one of the outstanding features of our the disclosed technology initialization scheme. The full capability of FLIP appear in scenarios where both the circuits and the objectives are varied. Rather than considering each task individually, FLIP provides a unified framework to learn good initial parameters over many problems, resulting in overall faster convergence.

In step 800, the parameterized quantum circuit (PQC) problem is defined as an initial ansatz and an objective. In step 810, using the encoder element of an encoder-decoder scheme, the PQC problem is mapped to a set of initial parameters K. In step 820, each of the K parameters is represented as fixed-size encoding vector containing information on the parameter, overall circuit, and objective. In step 830, using a trainable decoder, the K encodings are decoded by a neural network having weights and output as a single value per encoding. In step 840, a vector of initial parameters is generated based on the steps of encoding and decoding. In step 850, using these initial parameters as a starting point a gradient descent optimization is performed for S steps to minimize the meta-loss function. And finally, in step 860, the losses are backpropagated and used to update the weights of the decoder.

Although the first use case of applying FLIP to mitigate barren plateaus was demonstrated in a simple synthetic setting similar to those previously studied in the literature, it is further demonstrated that FLIP is a promising initialization technique for more complex problems. With FLIP, as long as there is some structure in the parameter space that can be learned by the framework, this can be exploited to adequately initialize new quantum circuits even when these circuits are larger than the ones seen during training.

A clear demonstration of learning these patterns is the application of FLIP to the max-cut instances in QAOA, in which it outperformed other proposed initialization techniques.

Enhancement over random initialization have been observed in the application to the 1D FHM instances, where the structure in the parameter space is not obvious even after training. The principles of the disclosed technology may be extended to other application domains, especially those that lack a problem Hamiltonian to guide the construction of the circuit ansatz. This can be shown, for example, the case for probabilistic generative modeling with Quantum Circuit Born Machines (QCBMs).

We highlight that our encoding-decoding scheme allows to fully condition the initial parameters with respect to specific details of the task-at-hand, e.g., the interaction strength of the parametrized Hamiltonians. This possibility to easily incorporate informative details of the task can be further explored and exploited.

In addition to training the initial parameters, the meta-learning aspect of FLIP may be readily used after initialization and could further contribute to more efficient optimizations.

Informed initialization of parameters may accelerate convergence and thus reduce the overall number of circuits to be run, which is critical for extending the application of VQAs to larger problem sizes. As gate-based quantum computing technologies mature, initialization techniques which embrace this unique flexibility of the disclosed technology will be essential to mitigate the challenges in trainability posed for PQC-based models and eventually scale to their application in real-world applications settings.

The methods described in this section and other sections for the technology disclosed can include one or more of the features described in connection with additional methods disclosed. In the interest of conciseness, the combinations of features disclosed in this application are not individually enumerated and are not repeated with each base set of features. The reader will understand how features identified in this method can readily be combined with sets of base features identified as implementations. The preceding description is presented to enable the making and use of the technology disclosed. Various modifications to the disclosed implementations will be apparent, and the general principles defined herein may be applied to other implementations and applications without departing from the spirit and scope of the technology disclosed. Thus, the technology disclosed is not intended to be limited to the implementations shown but is to be accorded the widest scope consistent with the principles and features disclosed herein. The scope of the technology disclosed is defined by the appended claims.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Various physical embodiments of a quantum computer are suitable for use according to the present disclosure. In general, the fundamental data storage unit in quantum computing is the quantum bit, or qubit. The qubit is a quantum-computing analog of a classical digital computer system bit. A classical bit is considered to occupy, at any given point in time, one of two possible states corresponding to the binary digits (bits) 0 or 1. By contrast, a qubit is implemented in hardware by a physical medium with quantum-mechanical characteristics. Such a medium, which physically instantiates a qubit, may be referred to herein as a “physical instantiation of a qubit,” a “physical embodiment of a qubit,” a “medium embodying a qubit,” or similar terms, or simply as a “qubit,” for ease of explanation. It should be understood, therefore, that references herein to “qubits” within descriptions of embodiments of the present invention refer to physical media which embody qubits.

Each qubit has an infinite number of different potential quantum-mechanical states. When the state of a qubit is physically measured, the measurement produces one of two different basis states resolved from the state of the qubit. Thus, a single qubit can represent a one, a zero, or any quantum superposition of those two qubit states; a pair of qubits can be in any quantum superposition of 4 orthogonal basis states; and three qubits can be in any superposition of 8 orthogonal basis states. The function that defines the quantum-mechanical states of a qubit is known as its wavefunction. The wavefunction also specifies the probability distribution of outcomes for a given measurement. A qubit, which has a quantum state of dimension two (i.e., has two orthogonal basis states), may be generalized to a d-dimensional “qudit,” where d may be any integral value, such as 2, 3, 4, or higher. In the general case of a qudit, measurement of the qudit produces one of d different basis states resolved from the state of the qudit. Any reference herein to a qubit should be understood to refer more generally to an d-dimensional qudit with any value of d.

Although certain descriptions of qubits herein may describe such qubits in terms of their mathematical properties, each such qubit may be implemented in a physical medium in any of a variety of different ways. Examples of such physical media include superconducting material, trapped ions, photons, optical cavities, individual electrons trapped within quantum dots, point defects in solids (e.g., phosphorus donors in silicon or nitrogen-vacancy centers in diamond), molecules (e.g., alanine, vanadium complexes), or aggregations of any of the foregoing that exhibit qubit behavior, that is, comprising quantum states and transitions therebetween that can be controllably induced or detected.

For any given medium that implements a qubit, any of a variety of properties of that medium may be chosen to implement the qubit. For example, if electrons are chosen to implement qubits, then the x component of its spin degree of freedom may be chosen as the property of such electrons to represent the states of such qubits. Alternatively, the y component, or the z component of the spin degree of freedom may be chosen as the property of such electrons to represent the state of such qubits. This is merely a specific example of the general feature that for any physical medium that is chosen to implement qubits, there may be multiple physical degrees of freedom (e.g., the x, y, and z components in the electron spin example) that may be chosen to represent 0 and 1. For any particular degree of freedom, the physical medium may controllably be put in a state of superposition, and measurements may then be taken in the chosen degree of freedom to obtain readouts of qubit values.

Certain implementations of quantum computers, referred to as gate model quantum computers, comprise quantum gates. In contrast to classical gates, there is an infinite number of possible single-qubit quantum gates that change the state vector of a qubit. Changing the state of a qubit state vector typically is referred to as a single-qubit rotation, and may also be referred to herein as a state change or a single-qubit quantum-gate operation. A rotation, state change, or single-qubit quantum-gate operation may be represented mathematically by a unitary 2×2 matrix with complex elements. A rotation corresponds to a rotation of a qubit state within its Hilbert space, which may be conceptualized as a rotation of the Bloch sphere. (As is well-known to those having ordinary skill in the art, the Bloch sphere is a geometrical representation of the space of pure states of a qubit.) Multi-qubit gates alter the quantum state of a set of qubits. For example, two-qubit gates rotate the state of two qubits as a rotation in the four-dimensional Hilbert space of the two qubits. (As is well-known to those having ordinary skill in the art, a Hilbert space is an abstract vector space possessing the structure of an inner product that allows length and angle to be measured. Furthermore, Hilbert spaces are complete: there are enough limits in the space to allow the techniques of calculus to be used.)

A quantum circuit may be specified as a sequence of quantum gates. As described in more detail below, the term “quantum gate,” as used herein, refers to the application of a gate control signal (defined below) to one or more qubits to cause those qubits to undergo certain physical transformations and thereby to implement a logical gate operation. To conceptualize a quantum circuit, the matrices corresponding to the component quantum gates may be multiplied together in the order specified by the gate sequence to produce a 2ⁿ×2ⁿ complex matrix representing the same overall state change on n qubits. A quantum circuit may thus be expressed as a single resultant operator. However, designing a quantum circuit in terms of constituent gates allows the design to conform to a standard set of gates, and thus enable greater ease of deployment. A quantum circuit thus corresponds to a design for actions taken upon the physical components of a quantum computer.

A given variational quantum circuit may be parameterized in a suitable device-specific manner. More generally, the quantum gates making up a quantum circuit may have an associated plurality of tuning parameters. For example, in embodiments based on optical switching, tuning parameters may correspond to the angles of individual optical elements.

In certain embodiments of quantum circuits, the quantum circuit includes both one or more gates and one or more measurement operations. Quantum computers implemented using such quantum circuits are referred to herein as implementing “measurement feedback.” For example, a quantum computer implementing measurement feedback may execute the gates in a quantum circuit and then measure only a subset (i.e., fewer than all) of the qubits in the quantum computer, and then decide which gate(s) to execute next based on the outcome(s) of the measurement(s). In particular, the measurement(s) may indicate a degree of error in the gate operation(s), and the quantum computer may decide which gate(s) to execute next based on the degree of error. The quantum computer may then execute the gate(s) indicated by the decision. This process of executing gates, measuring a subset of the qubits, and then deciding which gate(s) to execute next may be repeated any number of times. Measurement feedback may be useful for performing quantum error correction, but is not limited to use in performing quantum error correction. For every quantum circuit, there is an error-corrected implementation of the circuit with or without measurement feedback.

Some embodiments described herein generate, measure, or utilize quantum states that approximate a target quantum state (e.g., a ground state of a Hamiltonian). As will be appreciated by those trained in the art, there are many ways to quantify how well a first quantum state “approximates” a second quantum state. In the following description, any concept or definition of approximation known in the art may be used without departing from the scope hereof. For example, when the first and second quantum states are represented as first and second vectors, respectively, the first quantum state approximates the second quantum state when an inner product between the first and second vectors (called the “fidelity” between the two quantum states) is greater than a predefined amount (typically labeled ϵ). In this example, the fidelity quantifies how “close” or “similar” the first and second quantum states are to each other. The fidelity represents a probability that a measurement of the first quantum state will give the same result as if the measurement were performed on the second quantum state. Proximity between quantum states can also be quantified with a distance measure, such as a Euclidean norm, a Hamming distance, or another type of norm known in the art. Proximity between quantum states can also be defined in computational terms. For example, the first quantum state approximates the second quantum state when a polynomial time-sampling of the first quantum state gives some desired information or property that it shares with the second quantum state.

Not all quantum computers are gate model quantum computers. Embodiments of the present invention are not limited to being implemented using gate model quantum computers. As an alternative example, embodiments of the present invention may be implemented, in whole or in part, using a quantum computer that is implemented using a quantum annealing architecture, which is an alternative to the gate model quantum computing architecture. More specifically, quantum annealing (QA) is a metaheuristic for finding the global minimum of a given objective function over a given set of candidate solutions (candidate states), by a process using quantum fluctuations.

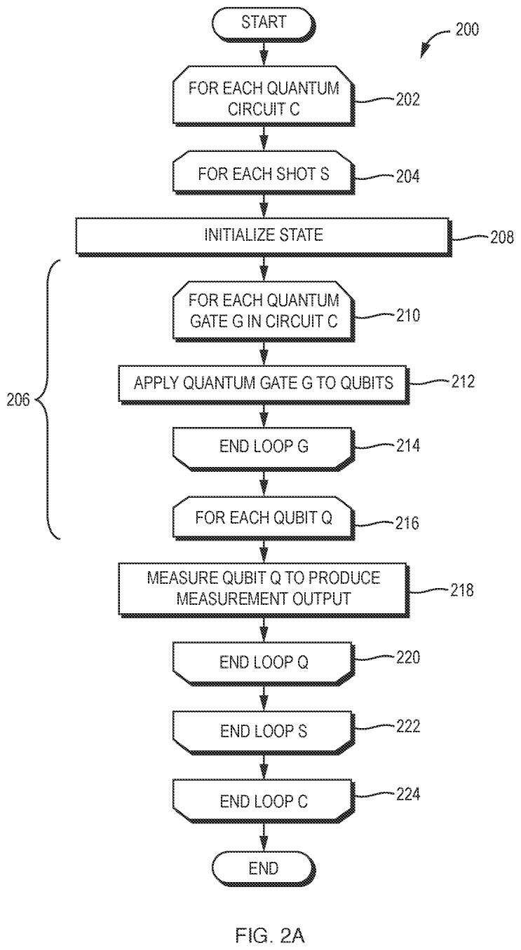

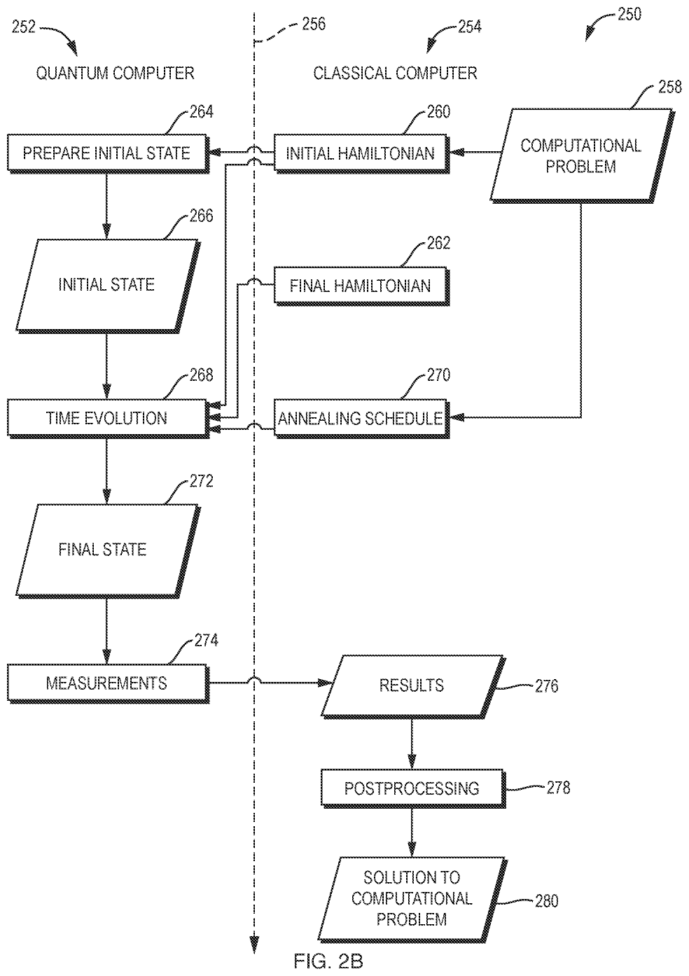

FIG. 2B shows a diagram illustrating operations typically performed by a computer system 250 which implements quantum annealing. The system 250 includes both a quantum computer 252 and a classical computer 254. Operations shown on the left of the dashed vertical line 256 typically are performed by the quantum computer 252, while operations shown on the right of the dashed vertical line 256 typically are performed by the classical computer 254.

Quantum annealing starts with the classical computer 254 generating an initial Hamiltonian 260 and a final Hamiltonian 262 based on a computational problem 258 to be solved, and providing the initial Hamiltonian 260, the final Hamiltonian 262 and an annealing schedule 270 as input to the quantum computer 252. The quantum computer 252 prepares a well-known initial state 266 (FIG. 2B, operation 264), such as a quantum-mechanical superposition of all possible states (candidate states) with equal weights, based on the initial Hamiltonian 260. The classical computer 254 provides the initial Hamiltonian 260, a final Hamiltonian 262, and an annealing schedule 270 to the quantum computer 252. The quantum computer 252 starts in the initial state 266, and evolves its state according to the annealing schedule 270 following the time-dependent Schrödinger equation, a natural quantum-mechanical evolution of physical systems (FIG. 2B, operation 268). More specifically, the state of the quantum computer 252 undergoes time evolution under a time-dependent Hamiltonian, which starts from the initial Hamiltonian 260 and terminates at the final Hamiltonian 262. If the rate of change of the system Hamiltonian is slow enough, the system stays close to the ground state of the instantaneous Hamiltonian. If the rate of change of the system Hamiltonian is accelerated, the system may leave the ground state temporarily but produce a higher likelihood of concluding in the ground state of the final problem Hamiltonian, i.e., diabatic quantum computation. At the end of the time evolution, the set of qubits on the quantum annealer is in a final state 272, which is expected to be close to the ground state of the classical Ising model that corresponds to the solution to the original optimization problem 258. An experimental demonstration of the success of quantum annealing for random magnets was reported immediately after the initial theoretical proposal.

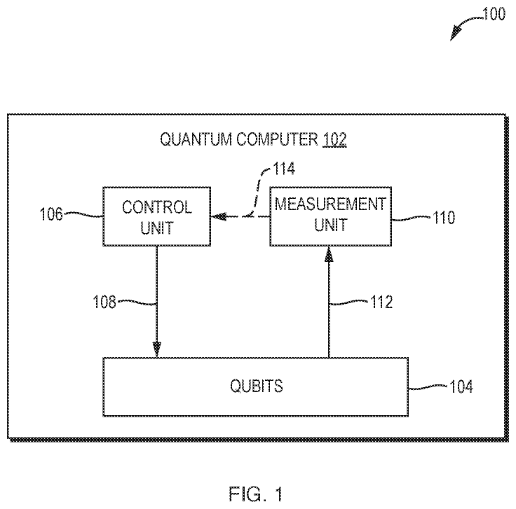

The final state 272 of the quantum computer 252 is measured, thereby producing results 276 (i.e., measurements) (FIG. 2B, operation 274). The measurement operation 274 may be performed, for example, in any of the ways disclosed herein, such as in any of the ways disclosed herein in connection with the measurement unit 110 in FIG. 1. The classical computer 254 performs postprocessing on the measurement results 276 to produce output 280 representing a solution to the original computational problem 258 (FIG. 2B, operation 278).

As yet another alternative example, embodiments of the present invention may be implemented, in whole or in part, using a quantum computer that is implemented using a one-way quantum computing architecture, also referred to as a measurement-based quantum computing architecture, which is another alternative to the gate model quantum computing architecture. More specifically, the one-way or measurement based quantum computer (MBQC) is a method of quantum computing that first prepares an entangled resource state, usually a cluster state or graph state, then performs single qubit measurements on it. It is “one-way” because the resource state is destroyed by the measurements.

The outcome of each individual measurement is random, but they are related in such a way that the computation always succeeds. In general the choices of basis for later measurements need to depend on the results of earlier measurements, and hence the measurements cannot all be performed at the same time.

Any of the functions disclosed herein may be implemented using means for performing those functions. Such means include, but are not limited to, any of the components disclosed herein, such as the computer-related components described below.

Referring to FIG. 1, a diagram is shown of a system 100 implemented according to one embodiment of the present invention. Referring to FIG. 2A, a flowchart is shown of a method 200 performed by the system 100 of FIG. 1 according to one embodiment of the present invention. The system 100 includes a quantum computer 102. The quantum computer 102 includes a plurality of qubits 104, which may be implemented in any of the ways disclosed herein. There may be any number of qubits 104 in the quantum computer 102. For example, the qubits 104 may include or consist of no more than 2 qubits, no more than 4 qubits, no more than 8 qubits, no more than 16 qubits, no more than 32 qubits, no more than 64 qubits, no more than 128 qubits, no more than 256 qubits, no more than 512 qubits, no more than 1024 qubits, no more than 2048 qubits, no more than 4096 qubits, or no more than 8192 qubits. These are merely examples, in practice there may be any number of qubits 104 in the quantum computer 102.

There may be any number of gates in a quantum circuit. However, in some embodiments the number of gates may be at least proportional to the number of qubits 104 in the quantum computer 102. In some embodiments the gate depth may be no greater than the number of qubits 104 in the quantum computer 102, or no greater than some linear multiple of the number of qubits 104 in the quantum computer 102 (e.g., 2, 3, 4, 5, 6, or 7).

The qubits 104 may be interconnected in any graph pattern. For example, they be connected in a linear chain, a two-dimensional grid, an all-to-all connection, any combination thereof, or any subgraph of any of the preceding.

As will become clear from the description below, although element 102 is referred to herein as a “quantum computer,” this does not imply that all components of the quantum computer 102 leverage quantum phenomena. One or more components of the quantum computer 102 may, for example, be classical (i.e., non-quantum components) components which do not leverage quantum phenomena.

The quantum computer 102 includes a control unit 106, which may include any of a variety of circuitry and/or other machinery for performing the functions disclosed herein. The control unit 106 may, for example, consist entirely of classical components. The control unit 106 generates and provides as output one or more control signals 108 to the qubits 104. The control signals 108 may take any of a variety of forms, such as any kind of electromagnetic signals, such as electrical signals, magnetic signals, optical signals (e.g., laser pulses), or any combination thereof.

For example:
In embodiments in which some or all of the qubits 104 are implemented as photons (also referred to as a “quantum optical” implementation) that travel along waveguides, the control unit 106 may be a beam splitter (e.g., a heater or a mirror), the control signals 108 may be signals that control the heater or the rotation of the mirror, the measurement unit 110 may be a photodetector, and the measurement signals 112 may be photons.
In embodiments in which some or all of the qubits 104 are implemented as charge type qubits (e.g., transmon, X-mon, G-mon) or flux-type qubits (e.g., flux qubits, capacitively shunted flux qubits) (also referred to as a “circuit quantum electrodynamic” (circuit QED) implementation), the control unit 106 may be a bus resonator activated by a drive, the control signals 108 may be cavity modes, the measurement unit 110 may be a second resonator (e.g., a low-Q resonator), and the measurement signals 112 may be voltages measured from the second resonator using dispersive readout techniques.
In embodiments in which some or all of the qubits 104 are implemented as superconducting circuits, the control unit 106 may be a circuit QED-assisted control unit or a direct capacitive coupling control unit or an inductive capacitive coupling control unit, the control signals 108 may be cavity modes, the measurement unit 110 may be a second resonator (e.g., a low-Q resonator), and the measurement signals 112 may be voltages measured from the second resonator using dispersive readout techniques.
In embodiments in which some or all of the qubits 104 are implemented as trapped ions (e.g., electronic states of, e.g., magnesium ions), the control unit 106 may be a laser, the control signals 108 may be laser pulses, the measurement unit 110 may be a laser and either a CCD or a photodetector (e.g., a photomultiplier tube), and the measurement signals 112 may be photons.
In embodiments in which some or all of the qubits 104 are implemented using nuclear magnetic resonance (NMR) (in which case the qubits may be molecules, e.g., in liquid or solid form), the control unit 106 may be a radio frequency (RF) antenna, the control signals 108 may be RF fields emitted by the RF antenna, the measurement unit 110 may be another RF antenna, and the measurement signals 112 may be RF fields measured by the second RF antenna.
In embodiments in which some or all of the qubits 104 are implemented as nitrogen-vacancy centers (NV centers), the control unit 106 may, for example, be a laser, a microwave antenna, or a coil, the control signals 108 may be visible light, a microwave signal, or a constant electromagnetic field, the measurement unit 110 may be a photodetector, and the measurement signals 112 may be photons.
In embodiments in which some or all of the qubits 104 are implemented as two-dimensional quasiparticles called “anyons” (also referred to as a “topological quantum computer” implementation), the control unit 106 may be nanowires, the control signals 108 may be local electrical fields or microwave pulses, the measurement unit 110 may be superconducting circuits, and the measurement signals 112 may be voltages.
In embodiments in which some or all of the qubits 104 are implemented as semiconducting material (e.g., nanowires), the control unit 106 may be microfabricated gates, the control signals 108 may be RF or microwave signals, the measurement unit 110 may be microfabricated gates, and the measurement signals 112 may be RF or microwave signals.

Although not shown explicitly in FIG. 1 and not required, the measurement unit 110 may provide one or more feedback signals 114 to the control unit 106 based on the measurement signals 112. For example, quantum computers referred to as “one-way quantum computers” or “measurement-based quantum computers” utilize such feedback 114 from the measurement unit 110 to the control unit 106. Such feedback 114 is also necessary for the operation of fault-tolerant quantum computing and error correction.

The control signals 108 may, for example, include one or more state preparation signals which, when received by the qubits 104, cause some or all of the qubits 104 to change their states. Such state preparation signals constitute a quantum circuit also referred to as an “ansatz circuit.” The resulting state of the qubits 104 is referred to herein as an “initial state” or an “ansatz state.” The process of outputting the state preparation signal(s) to cause the qubits 104 to be in their initial state is referred to herein as “state preparation” (FIG. 2A, section 206). A special case of state preparation is “initialization,” also referred to as a “reset operation,” in which the initial state is one in which some or all of the qubits 104 are in the “zero” state i.e. the default single-qubit state. More generally, state preparation may involve using the state preparation signals to cause some or all of the qubits 104 to be in any distribution of desired states. In some embodiments, the control unit 106 may first perform initialization on the qubits 104 and then perform preparation on the qubits 104, by first outputting a first set of state preparation signals to initialize the qubits 104, and by then outputting a second set of state preparation signals to put the qubits 104 partially or entirely into non-zero states.

Another example of control signals 108 that may be output by the control unit 106 and received by the qubits 104 are gate control signals. The control unit 106 may output such gate control signals, thereby applying one or more gates to the qubits 104. Applying a gate to one or more qubits causes the set of qubits to undergo a physical state change which embodies a corresponding logical gate operation (e.g., single-qubit rotation, two-qubit entangling gate or multi-qubit operation) specified by the received gate control signal. As this implies, in response to receiving the gate control signals, the qubits 104 undergo physical transformations which cause the qubits 104 to change state in such a way that the states of the qubits 104, when measured (see below), represent the results of performing logical gate operations specified by the gate control signals. The term “quantum gate,” as used herein, refers to the application of a gate control signal to one or more qubits to cause those qubits to undergo the physical transformations described above and thereby to implement a logical gate operation.

It should be understood that the dividing line between state preparation (and the corresponding state preparation signals) and the application of gates (and the corresponding gate control signals) may be chosen arbitrarily. For example, some or all the components and operations that are illustrated in FIGS. 1 and 2A-2B as elements of “state preparation” may instead be characterized as elements of gate application. Conversely, for example, some or all of the components and operations that are illustrated in FIGS. 1 and 2A-2B as elements of “gate application” may instead be characterized as elements of state preparation. As one particular example, the system and method of FIGS. 1 and 2A-2B may be characterized as solely performing state preparation followed by measurement, without any gate application, where the elements that are described herein as being part of gate application are instead considered to be part of state preparation. Conversely, for example, the system and method of FIGS. 1 and 2A-2B may be characterized as solely performing gate application followed by measurement, without any state preparation, and where the elements that are described herein as being part of state preparation are instead considered to be part of gate application.

The quantum computer 102 also includes a measurement unit 110, which performs one or more measurement operations on the qubits 104 to read out measurement signals 112 (also referred to herein as “measurement results”) from the qubits 104, where the measurement results 112 are signals representing the states of some or all of the qubits 104. In practice, the control unit 106 and the measurement unit 110 may be entirely distinct from each other, or contain some components in common with each other, or be implemented using a single unit (i.e., a single unit may implement both the control unit 106 and the measurement unit 110). For example, a laser unit may be used both to generate the control signals 108 and to provide stimulus (e.g., one or more laser beams) to the qubits 104 to cause the measurement signals 112 to be generated.

In general, the quantum computer 102 may perform various operations described above any number of times. For example, the control unit 106 may generate one or more control signals 108, thereby causing the qubits 104 to perform one or more quantum gate operations. The measurement unit 110 may then perform one or more measurement operations on the qubits 104 to read out a set of one or more measurement signals 112. The measurement unit 110 may repeat such measurement operations on the qubits 104 before the control unit 106 generates additional control signals 108, thereby causing the measurement unit 110 to read out additional measurement signals 112 resulting from the same gate operations that were performed before reading out the previous measurement signals 112. The measurement unit 110 may repeat this process any number of times to generate any number of measurement signals 112 corresponding to the same gate operations. The quantum computer 102 may then aggregate such multiple measurements of the same gate operations in any of a variety of ways.

After the measurement unit 110 has performed one or more measurement operations on the qubits 104 after they have performed one set of gate operations, the control unit 106 may generate one or more additional control signals 108, which may differ from the previous control signals 108, thereby causing the qubits 104 to perform one or more additional quantum gate operations, which may differ from the previous set of quantum gate operations. The process described above may then be repeated, with the measurement unit 110 performing one or more measurement operations on the qubits 104 in their new states (resulting from the most recently-performed gate operations).

In general, the system 100 may implement a plurality of quantum circuits as follows. For each quantum circuit C in the plurality of quantum circuits (FIG. 2A, operation 202), the system 100 performs a plurality of “shots” on the qubits 104. The meaning of a shot will become clear from the description that follows. For each shot S in the plurality of shots (FIG. 2A, operation 204), the system 100 prepares the state of the qubits 104 (FIG. 2A, section 206). More specifically, for each quantum gate Gin quantum circuit C (FIG. 2A, operation 210), the system 100 applies quantum gate G to the qubits 104 (FIG. 2A, operations 212 and 214).

Then, for each of the qubits Q 104 (FIG. 2A, operation 216), the system 100 measures the qubit Q to produce measurement output representing a current state of qubit Q (FIG. 2A, operations 218 and 220).

The operations described above are repeated for each shot S (FIG. 2A, operation 222), and circuit C (FIG. 2A, operation 224). As the description above implies, a single “shot” involves preparing the state of the qubits 104 and applying all of the quantum gates in a circuit to the qubits 104 and then measuring the states of the qubits 104; and the system 100 may perform multiple shots for one or more circuits.

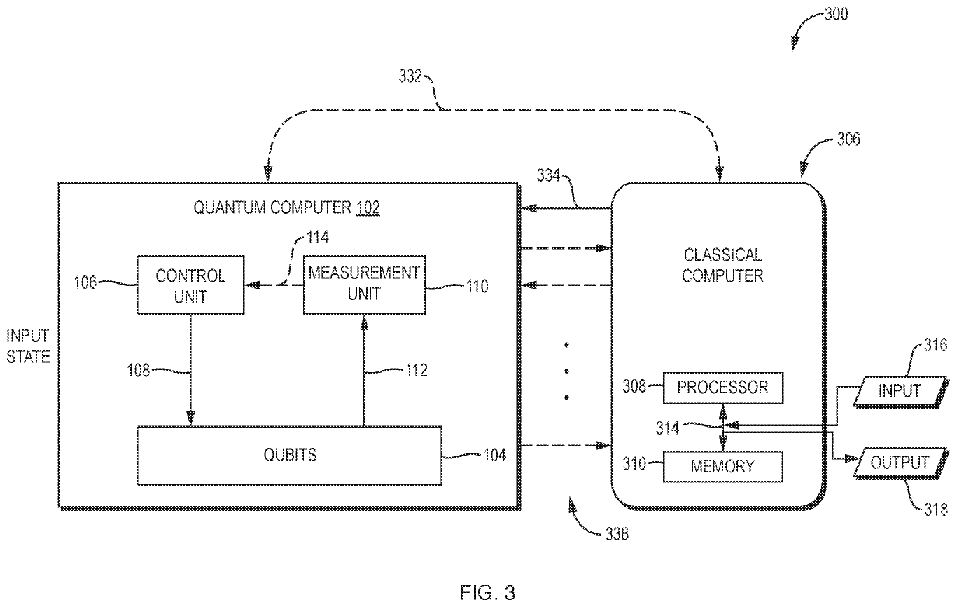

Referring to FIG. 3, a diagram is shown of a hybrid quantum classical computer (HQC) 300 implemented according to one embodiment of the present invention. The HQC 300 includes a quantum computer component 102 (which may, for example, be implemented in the manner shown and described in connection with FIG. 1) and a classical computer component 306. The classical computer component may be a machine implemented according to the general computing model established by John Von Neumann, in which programs are written in the form of ordered lists of instructions and stored within a classical (e.g., digital) memory 310 and executed by a classical (e.g., digital) processor 308 of the classical computer. The memory 310 is classical in the sense that it stores data in a storage medium in the form of bits, which have a single definite binary state at any point in time. The bits stored in the memory 310 may, for example, represent a computer program. The classical computer component 304 typically includes a bus 314. The processor 308 may read bits from and write bits to the memory 310 over the bus 314. For example, the processor 308 may read instructions from the computer program in the memory 310, and may optionally receive input data 316 from a source external to the computer 302, such as from a user input device such as a mouse, keyboard, or any other input device. The processor 308 may use instructions that have been read from the memory 310 to perform computations on data read from the memory 310 and/or the input 316, and generate output from those instructions. The processor 308 may store that output back into the memory 310 and/or provide the output externally as output data 318 via an output device, such as a monitor, speaker, or network device.

The quantum computer component 102 may include a plurality of qubits 104, as described above in connection with FIG. 1. A single qubit may represent a one, a zero, or any quantum superposition of those two qubit states. The classical computer component 304 may provide classical state preparation signals 332 to the quantum computer 102, in response to which the quantum computer 102 may prepare the states of the qubits 104 in any of the ways disclosed herein, such as in any of the ways disclosed in connection with FIGS. 1 and 2A-2B.

Once the qubits 104 have been prepared, the classical processor 308 may provide classical control signals 334 to the quantum computer 102, in response to which the quantum computer 102 may apply the gate operations specified by the control signals 332 to the qubits 104, as a result of which the qubits 104 arrive at a final state. The measurement unit 110 in the quantum computer 102 (which may be implemented as described above in connection with FIGS. 1 and 2A-2B) may measure the states of the qubits 104 and produce measurement output 338 representing the collapse of the states of the qubits 104 into one of their eigenstates. As a result, the measurement output 338 includes or consists of bits and therefore represents a classical state. The quantum computer 102 provides the measurement output 338 to the classical processor 308. The classical processor 308 may store data representing the measurement output 338 and/or data derived therefrom in the classical memory 310.

The steps described above may be repeated any number of times, with what is described above as the final state of the qubits 104 serving as the initial state of the next iteration. In this way, the classical computer 304 and the quantum computer 102 may cooperate as co-processors to perform joint computations as a single computer system.

Although certain functions may be described herein as being performed by a classical computer and other functions may be described herein as being performed by a quantum computer, these are merely examples and do not constitute limitations of the present invention. A subset of the functions which are disclosed herein as being performed by a quantum computer may instead be performed by a classical computer. For example, a classical computer may execute functionality for emulating a quantum computer and provide a subset of the functionality described herein, albeit with functionality limited by the exponential scaling of the simulation. Functions which are disclosed herein as being performed by a classical computer may instead be performed by a quantum computer.

The techniques described above may be implemented, for example, in hardware, in one or more computer programs tangibly stored on one or more computer-readable media, firmware, or any combination thereof, such as solely on a quantum computer, solely on a classical computer, or on a hybrid quantum classical (HQC) computer. The techniques disclosed herein may, for example, be implemented solely on a classical computer, in which the classical computer emulates the quantum computer functions disclosed herein.

Any reference herein to the state |0 [symbol] may alternatively refer to the state |1 [symbol] , and vice versa. In other words, any role described herein for the states |0 [symbol] and |1 [symbol] may be reversed within embodiments of the present invention. More generally, any computational basis state disclosed herein may be replaced with any suitable reference state within embodiments of the present invention.

The techniques described above may be implemented in one or more computer programs executing on (or executable by) a programmable computer (such as a classical computer, a quantum computer, or an HQC) including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

Embodiments of the present invention include features which are only possible and/or feasible to implement with the use of one or more computers, computer processors, and/or other elements of a computer system. Such features are either impossible or impractical to implement mentally and/or manually. For example, embodiments of the present invention use a neural network to decode a plurality of decodings and use a hybrid quantum-classical computer to perform a gradient descent (GD) optimization to minimize a meta-loss function. These functions are inherently rooted in computer technology and cannot be performed mentally or manually.

Any claims herein which affirmatively require a computer, a processor, a memory, or similar computer-related elements, are intended to require such elements, and should not be interpreted as if such elements are not present in or required by such claims. Such claims are not intended, and should not be interpreted, to cover methods and/or systems which lack the recited computer-related elements. For example, any method claim herein which recites that the claimed method is performed by a computer, a processor, a memory, and/or similar computer-related element, is intended to, and should only be interpreted to, encompass methods which are performed by the recited computer-related element(s). Such a method claim should not be interpreted, for example, to encompass a method that is performed mentally or by hand (e.g., using pencil and paper). Similarly, any product claim herein which recites that the claimed product includes a computer, a processor, a memory, and/or similar computer-related element, is intended to, and should only be interpreted to, encompass products which include the recited computer-related element(s). Such a product claim should not be interpreted, for example, to encompass a product that does not include the recited computer-related element(s).

In embodiments in which a classical computing component executes a computer program providing any subset of the functionality within the scope of the claims below, the computer program may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor, which may be either a classical processor or a quantum processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A classical computer can generally also receive (read) programs and data from, and write (store) programs and data to, a non-transitory computer-readable storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium (such as a classical computer-readable medium, a quantum computer-readable medium, or an HQC computer-readable medium). Embodiments of the invention may store such data in such data structure(s) and read such data from such data structure(s).

Although terms such as “optimize” and “optimal” are used herein, in practice, embodiments of the present invention may include methods which produce outputs that are not optimal, or which are not known to be optimal, but which nevertheless are useful. For example, embodiments of the present invention may produce an output which approximates an optimal solution, within some degree of error. As a result, terms herein such as “optimize” and “optimal” should be understood to refer not only to processes which produce optimal outputs, but also processes which produce outputs that approximate an optimal solution, within some degree of error.

What is claimed is:

1. A method, performed on a hybrid quantum-classical computer system for computing initializing parameters for a parametrized quantum circuit (PQC), the hybrid quantum-classical computer system comprising a classical computer and a quantum computer,
the classical computer including a processor, a non-transitory computer-readable medium, and computer instructions stored in the non-transitory computer-readable medium;
the quantum computer including a quantum component, having a plurality of qubits, which accepts a sequence of instructions to evolve a quantum state based on a series of quantum gates;
wherein the computer instructions, when executed by the processor, perform the method, the method comprising:
defining a PQC problem having a parametrized circuit ansatz and an objective, based on a system size comprising N qubits and a quantum circuit with K parameters;
using an encoder of an encoder-decoder, mapping the PQC problem to a set of initial parameters, wherein each parameter k in the K parameters is represented as a corresponding encoding vector, the corresponding encoding vector containing information about the parameter k, the quantum circuit, and the objective C;
using a trainable decoding element of the encoder-decoder, decoding the K encodings by a neural network having a plurality of weights and wherein a single value is output for each corresponding encoding vector;
generating a vector of initial parameters having a dimension equal to K;
using the vector of initial parameters as a starting point, performing a gradient descent (GD) optimization for S steps to minimize a meta-loss function having a loss as output; and
backpropagating the loss to update the plurality of weights,
whereby initializing parameters are generated, which incorporate relevant information about the objective C, to produce a fully problem-dependent set of initial parameters.

2. The method of claim 1, wherein each of the corresponding encoding vectors contains information about the objective.

3. The method of claim 1, wherein each of the corresponding encoding vectors is a fixed size and uniquely represents the corresponding one of the K parameters.

4. The method of claim 1, wherein the generation of the vector of initial parameters is accelerated relative to random generation of initial parameters.

5. The method of claim 1, wherein the initialization method uses machine learning to provide a flexible initializer for arbitrarily-sized parametrized quantum circuits.

6. The method of claim 1, further comprising applying the method to quantum circuits of varying sizes.

7. The method of claim 1, wherein the method is applied to learning arbitrarily-sized quantum circuits.

8. The method of claim 1, wherein encoding vectors are fully defined by the PQC problem.

9. The method of claim 1, whereby the method computes the initializing parameters for QAOA applied to max-cut problems.

10. The method of claim 1, whereby the method computes the initializing parameters for optimizing the 1D Fermi-Hubbard model (1D) FHM.

11. The method of claim 1, wherein performing the GD optimization comprises minimizing local minima.

12. The method of claim 1, wherein performing the GD optimization comprises minimizing barren plateaus.

13. The method of claim 1, wherein the parametrized circuit ansatz comprises a Low Depth Circuit Ansatz (LDCA).

14. A hybrid quantum-classical computer system for computing the initializing parameters for a parametrized quantum circuit (PQC), the computer system comprising a classical computer and a quantum computer,
the classical computer including a processor, a non-transitory computer-readable medium, and computer instructions stored in the non-transitory computer-readable medium;
the quantum computer including a quantum component, having a plurality of qubits, which accepts a sequence of instructions to evolve a quantum state based on a series of quantum gates;
wherein the computer instructions, when executed by the processor, perform the method, the method comprising:
defining a PQC problem having a parametrized circuit ansatz and an objective which can be estimated through repeated measurements on the output state, based a system size comprising N qubits and a quantum circuit with K parameters;
using an encoder element of a encoder-decoder, mapping the PQC problem to a set of initial parameters, wherein each of the K parameters is represented as an encoding vector, the encoding vector containing information about the parameter, the overall circuit, and the objective;
using a trainable decoding element of the encoder-decoder, decoding the K encodings by a neural network having weight and wherein a single value is output for each encoding;
generating a vector of initial parameters having a dimension matching K parameters;
using the vector of initial parameters as a starting point, performing a gradient descent (GD) optimization for S steps to minimize the meta-loss function; and
backpropagating the loss to update the weights of the decoder.

15. The system of claim 1, wherein the encoding vector contains information about the objective.

16. The system of claim 1, wherein each of the encodings is a fixed size and uniquely represents each parameter.

17. The system of claim 1, wherein the optimization method accelerates initial parameters generation.

18. The system of claim 1, wherein learning a set of initial parameters is efficiently refined by gradient descent GD.

19. The system of claim 1, wherein the method uses meta-learning.

20. The system of claim 1, wherein the method is applied to quantum circuits of varying sizes.

21. The system of claim 1, wherein the method is applied for learning arbitrarily-sized quantum circuits.

22. The system of claim 1, wherein initial parameters are fully defined by the PQC problem.

23. The system of claim 1, wherein the set of initial parameters are computed for QAOA applied to max-cut problems.

24. The system of claim 1, wherein the set of initial parameters are computed for optimizing the 1D Fermi-Hubbard model (1D) FHM.

25. The system of claim 1, wherein local minima are minimized.

26. The system of claim 1, wherein barren plateaus are minimized.

27. The system of claim 1, wherein the quantum circuit ansatz is a Low Depth Circuit Ansatz (LDCA).

28. A method for solving a parameterized quantum circuit (PQC) problem for a system having N qubits and K parameters, the problem comprising a parametrized circuit ansatz and an objective C;
defining a PQC problem having a parametrized circuit ansatz and an objective which can be estimated through repeated measurements on the output state, based a system size comprising N qubits and a quantum circuit with K parameters;
using an encoder element of a encoder-decoder, mapping the PQC problem to a set of initial parameters, wherein each of the K parameters is represented as an encoding vector, the encoding vector containing information about the parameter, the overall circuit, and the objective;
using a trainable decoding element of the encoder-decoder, decoding the K encodings by a neural network having weight and wherein a single value is output for each encoding;
generating a vector of initial parameters having a dimension matching K parameters;
using the vector of initial parameters as a starting point, performing a gradient descent (GD) optimization for S steps to minimize the meta-loss function; and
backpropagating the loss to update the weights of the decoder.
